(19) United States
(12) Patent Application Publication
(10) Pub. No.: US 2016/0181690 A1
(43) Pub. Date: Jun. 23, 2016

(54) PENTABAND ANTENNA

(71) Applicant: WIRELESS RESEARCH DEVELOPMENT, Temecula, CA (US)

(72) Inventors: Henry Cooper, Temecula, CA (US); Sheng Peng, Lynwood, WA (US)

(21) Appl. No.: 14/429,716

(22) PCT Filed: Sep. 18, 2013
(86) PCT No.: PCT/US13/60462

§ 371 Date: Aug. 25, 2015

Related U.S. Application Data
(60) Provisional application No. 61/703,083, filed on Sep. 19, 2012.

(51) Int. Cl. H01Q 1/38; H01Q 9/04

(52) U.S. Cl. CPC H01Q 1/38; H01Q 9/0414

(57) ABSTRACT

An antenna element is disclosed which is formed in a unitary structure featuring a planar ground plane portion formed of electrically conductive material engaged with a perpendicular radiator element. One or a plurality of gaps formed into the radiator element provide one or a plurality of additional antenna elements which may be horizontally or vertically disposed for accommodating horizontally or vertically polarized RF transmission and reception.

### BACKGROUND OF THE INVENTION

1. Field of the Invention

This application claims priority to U.S. Provisional Patent Application Ser. No. 61/703083 filed on Sep. 19, 2012, and is incorporated herein in its entirety by this reference.

The present invention relates to antennas for transmission and reception of radio frequency (RF) communications. More particularly the invention relates to an antenna element configured for RF communication across a plurality of bandwidths and in both horizontal and vertical polarization schemes. Due to the plurality of polarizations and frequencies, the antenna element is especially well adapted for employment with site surveying and positioning systems employing global navigation satellite systems for high accuracy site measurements.

2. Prior Art

Radio transmission and reception devices which use a plurality of frequencies and employ a plurality of RF polarization schemes, generally must employ a plurality of different antennas to accommodate the differing wavelength requirements and frequencies received and broadcast. One example is that of site surveying which conventionally involves the tasks of measuring and verifying ground levels and other site features, checking finished grade and laid material thickness against design elevations and tolerances, computing progress and material stockpile volumes, as well as many other pertinent tasks. In order to obtain accurate measurements of elevation, distance, thickness, and the like, surveyors commonly employ instruments having antenna elements configured for communication with satellite positioning system of specified bandwidths, such as a global navigation satellite systems (GNSS) or global positioning systems (GPS). Both operate on differing frequencies.

For GNSS and GPS systems, it is known that the atmosphere distorts the satellite signal. Therefor many surveying systems will employ a stationary base station receiver in combination with one or a plurality of moveable (rover) receivers which communicate with the satellite. The base station is conventionally anchored on a fixed point on the earth and is employed to calculate the offset needed to correct the atmospheric distortion. This is a continuous RF signal which is sent via RF communication to the rover or portable receivers to provide the most accurate portable receiver position on the earth.

As such, these devices for ideal operation must employ a plurality of individual antennas configured for both the satellite system bandwidths, for location determination, and for communication at other bandwidths for local communication amongst the devices and/or with users employing computers and/or smartphones over other frequencies such as Wi-Fi, bluetooth and cellular. Additionally, the polarizations of the RF signals between satellites and earth-located receivers can differ.

However, the requirement to employ antennas with such broad capabilities results in surveying systems which are relatively bulky and do not provide adequate RF transmission and reception capabilities in all the desired frequencies and bandwidths due to interference and the like. Further, while surveying systems is the primary focus of this disclosure as an example of employment of multiple antennas for multiple receivers, the disclosure herein should not be in any fashion limited to such use. Those skilled in the art will realize upon reading this disclosure that the system and antenna herein can be employed on any number of RF transmission and receiving devices, and such is anticipated within the scope of this application.

Conventional antennas employed for RF transmission and reception generally take the form of large cumbersome conic or Yagi type construction. These antennas are somewhat fragile as they are formed by the combination of a plurality of parts including reflectors and receiving elements formed of light weight aluminum tubing or the like having various lengths to satisfy the frequency requirements of the received signals and plastic insulators. The receiving elements are held in relative position by means of the insulators and the reflectors elements are grounded together.

However, in addition to being bulky and multiple in nature, these and many other prior art antennas fail to provide the high precision requirements of surveying and GPS systems, and are relative bulky. There has not been a highly signal sensitive and easily constructed relatively small antenna for employment within a plurality of desired frequency bands.

As such, there is a continuing unmet need for an improved antenna radiator and reception element which is configured for transmission and reception capabilities terrestrially in a plurality of frequencies, and polarization schemes, which is especially well suited for receiving signals from remote satellites and terrestrial transmitters, as well as providing a plurality of frequencies for local transmission and reception such as for precise location-determining radio signals to instruments employing satellite positioning systems. Further, such a device should be employable with both horizontal and vertical polarized frequency bands.

### SUMMARY OF THE INVENTION

The device herein disclosed and described provides a solution to the shortcomings in prior art and achieves the above noted goals through the provision of an antenna element or radiator element which is uniquely shaped to provide excellent transmission and reception capability across a plurality of frequencies and polarizations and is especially well adapted for employment with RF systems which interconnect between local terrestrial stations, remote terrestrial stations, and satellite based systems, such as site surveying measuring equipment configured with one or a combination of satellite, cellular, Wi-Fi and bluetooth communication means.

The radiator element of the instant invention can be any suitable conductive material, as for example, aluminum, copper, silver, gold, platinum or any other electrical conductive material suitable for the purpose intended.

In a particularly preferred embodiment, the device forming the antenna element is a single structure and has the a ground plane portion running horizontally which operationally supports and is engaged to an orthogonally opposed radiator element. In a preferred as used mode, with the device engaged to underlying circuitry, the ground plane is preferably configured to sufficiently cover underlying an circuit board in order to diffract stray RF which may otherwise interfere with the RF signal feed into the circuitry. The large area ground plane additionally improves the distance of propagation for local RF transmission and reception. Further, the orthogonally disposed radiator element includes portions which are configured for both horizontal and vertical polarized frequency reception and transmission.

The radiator element has at least one serpentine or meander line cavity extending along a path from a mouth region starting at a terminating edge of the element to a terminating end point substantially centered in the element. Extending from the mouth at the edge of the ground plane portion of the element, the cavity defining the meanderline element then makes three right angled extensions in a meander line fashion and continues toward the terminating end of the cavity.

Along the path of the cavity, there is included a first vertically disposed portion of the antenna element herein, followed by a right angled turn to a first horizontally disposed portion, both preferably of the same gap size. This gap size extending along the first horizontal and vertical portions of the cavity determines a first frequency of which the device is capable of horizontal and vertical polarized RF transmission and reception.

In addition, continuing along the path of the cavity, there is another right angled turn followed by a second vertically disposed portion followed again by a right angled turn to a second horizontally disposed portion. These two portion are again of preferably the same gap size, however different than the first. Therefor, the gap size of these portions determine a second frequency of which the device is capable of horizontal and vertical polarized RF transmission and reception. The second horizontally disposed portion terminates at the terminating end of the path of the cavity.

The radiator element additionally includes additional notches, cavities, or gaps having various preferred gap sizes which are configured and oriented for vertical polarized frequency reception and transmission. Preferably, there are three additional notches or cavities. Therefor the disclosed antenna element device is comprised of five preferred frequency bands of RF communication, thus coining the term penta-band antenna. Of course more or less may also be employed for other purposes where local and distant RR communication are desired.

The formed radiator element and ground plane are of selective surface areas and may include various apertures communicating through the conductive material selectively positioned to help with impedance matching of the received signal.

Engagement of the radiator element to the ground plane is provided in a first preferred mode by forming the radiator element and ground plane as a unitary structure and bending the planar metal forming the antenna element to an orthogonally opposed position. However, in other preferred modes the radiator element and ground plane can be separately formed and engaged by any suitable engagement means, such as soldering, welding, or the like to form the unitary structure of multiple antenna elements in a single component.

An electrical connector extends to a tap position on the radiator element to electrically connect the element with an input/output port, such as a coaxial connector. Those skilled in the art will appreciate that the electrical connector can be of any type and should therefor not be considered limited to a coaxial connector.

The cross sectional area of the cavity, and the size and shape of the ground plane and radiator element, the location and position of the tap of the feedline, are of the antenna designers choice for best results for a given use and frequency. However, because the disclosed radiator element performs so well, across such a wide bandwidth, the current mode of the radiator element as depicted herein, with the connection point shown, is especially preferred. Of course those skilled in the art will realize that shape cavity, and the size and shape of the ground plane may be adjusted to fine tune impedance matching, increase gain in certain frequencies or for other reasons known to the skilled, and any and all such changes or alterations of the depicted radiator element as would occur to those skilled in the art upon reading this disclosure are anticipated within the scope of this invention.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide an antenna element device having a radiator or antenna element configured for RF communication in five preferred frequency band and having an orthogonally opposed ground plane.

It is another object of the invention to provide a unitary structure antenna element operating on a plurality of frequencies and polarizations.

It is another object of the invention to provide an antenna which is especially well adapted for employment in site surveying and measuring equipment.

These and other objects, features, and advantages of the invention will be brought out in the following part of the specification, wherein detailed description is for the purpose of fully disclosing the invention without placing limitations thereon.

### BRIEF DESCRIPTION OF DRAWING FIGURES

FIG. 1 shows a top view of the formed antenna device.

FIG. 2 is a first side view of the antenna device depicting the radiator element.

FIG. 3 shows the S₁₁ log magnitude plot of the particularly preferred mode of the device.

FIG. 4 shows the most preferred radiation plots of the device.

FIG. 5 shows a return loss vs. frequency plot of the device.

FIG. 6 shows a representation of the current density of the antenna device at 2.4 GHz, with the electric fields generated by the current, as defined by Maxwell's equations.

FIG. 7 shows a representation of the current density of the antenna device at 2 GHz.

FIG. 8 shows a representation of the current density of the antenna device at 1.85 GHz.

FIG. 9 shows a representation of the current density of the antenna device at 1.8 GHz.

FIG. 10 shows a representation of the current density of the antenna device at 1.6 GHz.

FIG. 11 shows a representation of the current density of the antenna device at 1.15 GHz.

FIG. 12 shows a representation of the current density of the antenna device at 0.95 GHz.

FIG. 13 shows a representation of the current density of the antenna device at 0.85 GHz.

### DETAILED DESCRIPTION OF THE PREFERRED EMBODIMENTS OF THE INVENTION

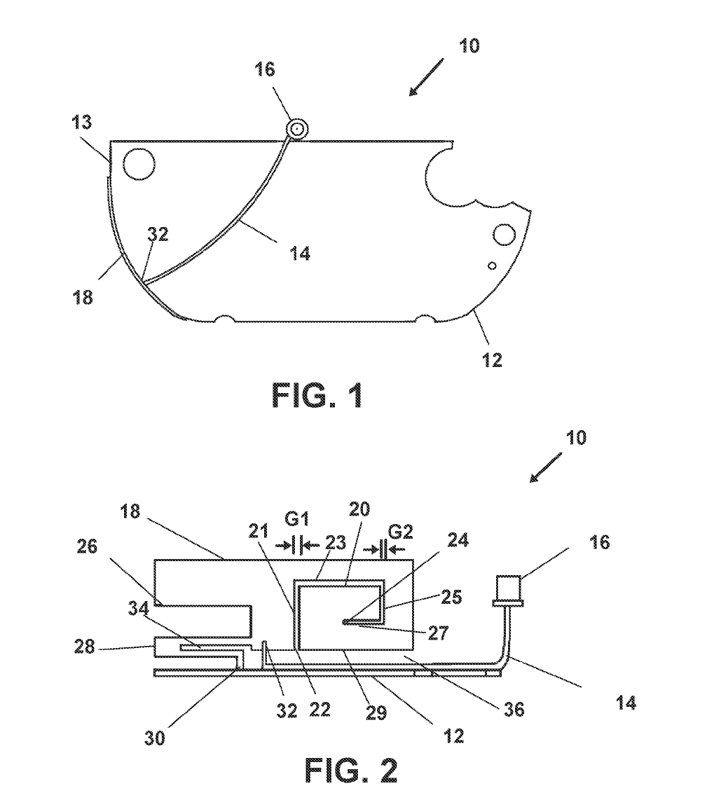

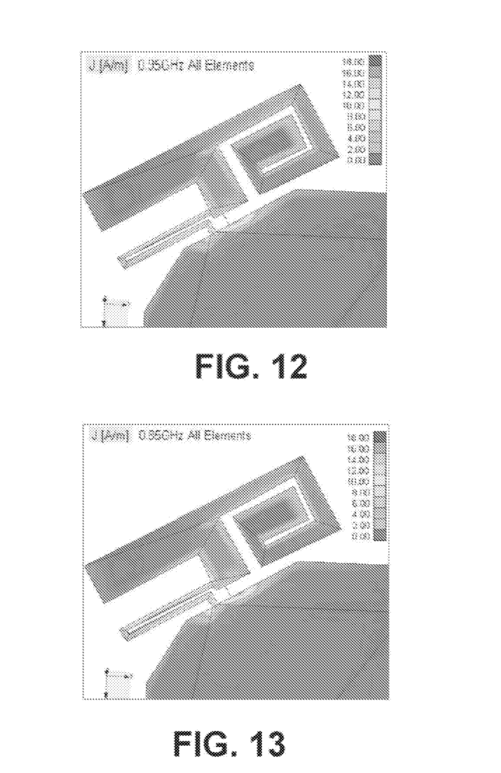

Now referring to drawings in FIGS. 1-13, wherein similar components are identified by like reference numerals, there is seen in FIG. 1 and FIG. 2 views of a particularly preferred mode of the antenna device 10 having a ground plane 12 and a first radiator element orthogonally opposed radiator element 18.

The device 10 is formed from a conductive material as for example, including but not limited to aluminum, copper, silver, gold, platinum or any other electrical conductive material which is suitable for the purpose intended. Further, in other preferred modes, the first radiator element 18 and ground plane 12 may be formed by coating a non-conductive substrate with the conductive material or more preferably by forming it from solid metal.

If formed from the non conductive substrate may be constructed of, for instance, either a rigid or flexible material such as, MYLAR, fiberglass, REXLITE, polystyrene, polyamide, TEFLON fiberglass, or any other dielectric material which would be suitable for the purpose intended. The coating of the substrate with the conductive material may be by microstripline or the like or other metal and substrate construction well known in this art. Any means for affixing the conductive material to the substrate is acceptable to practice this invention.

If the first radiator element 18 and ground plane 12 are formed from solid metal material, it may be formed in two joined pieces, or of a single piece where the ground plane 18 is cut to shape and the radiator element 18 is cut to shape and then bent having a perimeter defining an area configured to block RF signals from the vertically disposed element from communicating through the ground plane 18 to underlying circuitry. The radiator element perpendicular to the ground plane 18.

The first radiator element 18 in all modes of the device herein has at least one serpentining meander line antenna defined by cavity 20 extending along a path from a mouth region 22 starting at a terminating edge 29 of the element 18 to a terminating end point 24 substantially centered in the element 18.

Extending from the mouth 22 at the edge 29 of the element 29, the cavity 20 then makes three right angled extensions in a meander line fashion and continues toward the terminating end 24 of the cavity 20. Along the path of the cavity 20, there is included a first vertically disposed portion 21 followed by a right angled turn to a first horizontally disposed portion 23, both shown in of the same gap size ‘G1’. This gap G1 extending along the first horizontal 23 and vertical 21 portions of the cavity 20 favors transmission and reception in a first frequency of which the device 10 is capable of horizontal and vertical polarized RF transmission and reception.

Further, as can be seen, there is another right angled turn followed by a second vertically disposed portion 25 followed again by a right angled turn to a second horizontally disposed portion 27. These two portion 25, 27 as shown are substantially the same gap size ‘G2’, however different than the first ‘G1’. Therefor, the gap size ‘G2’ of these portions 25, 27 favor a second frequency range of which the device 10 is capable of horizontal and vertical polarized RF transmission and reception. The second horizontally disposed portion 27 terminates at the terminating end 24 of the path of the cavity 20.

Currently, serpentining cavity 20 provides excellent transmission and reception capabilities in horizontal and vertical polarized frequencies in a preferred range of 1.5 ghz to 2.4 ghz with especially good transmission and reception at measured points of 1.5 MHZ, 1.6 MHZ, 1.8 MHZ, 2.4 MHZ in horizontal and vertical polarizations depending on the position of the antenna element. Of course those skilled in the art will realize that the shape, gap size, and configuration of the cavity 20 may be adjusted to fine tune frequency response and impedance matching, and thereby increase gain in certain frequencies or for other reasons known to the skilled, and any and all such changes or alterations of the depicted radiator element 18 as would occur to those skilled in the art upon reading this disclosure are anticipated within the scope of this invention.

The radiator element 18 also includes a plurality of additional notches, cavities, or gaps configured fro vertical polarized RF communication. As is shown, there is a first rectangular notch 26 configured for vertical polarized RF communication capabilities. The location, depth, and width of the notch 26 may be adjusted by the designers choice to fine tune the reception and transmission characteristics of the element 18. Currently, notch 26 provides excellent transmission and reception capabilities in vertical polarized frequencies in a preferred range of 1.5 MHZ to 2.4 MHZ.

A second notch 34 is also provided, which is configured for vertical polarized RF communication in a preferred frequency range between the ranges noted. Lastly, comprising a fifth frequency for RF communication, there is an additional gap 36 provided between the bottom terminating edge 29 of the element 18 and the edge 13 of the ground plane 12. This gap 36 is sized to a configuration for RF communication at a point within the frequency range of 1.5-2.4 MHZ.

Near the proximal terminating edge 29 of the radiator element 18, a feedline 28 extends to an engagement 30 with a portion of a terminating edge 13 of the ground plane 12. There is additionally shown an electrical wire 14 and connector 14 engaged at a tap position 32 on the radiator element, proximal the feedline 28. The engagement 30 and tap 32 may be accomplished by soldering, welding, sonic welding, or other suitable means known in this art. The connector 14 may be a coaxial connector, or other suitable electric connector known in the art.

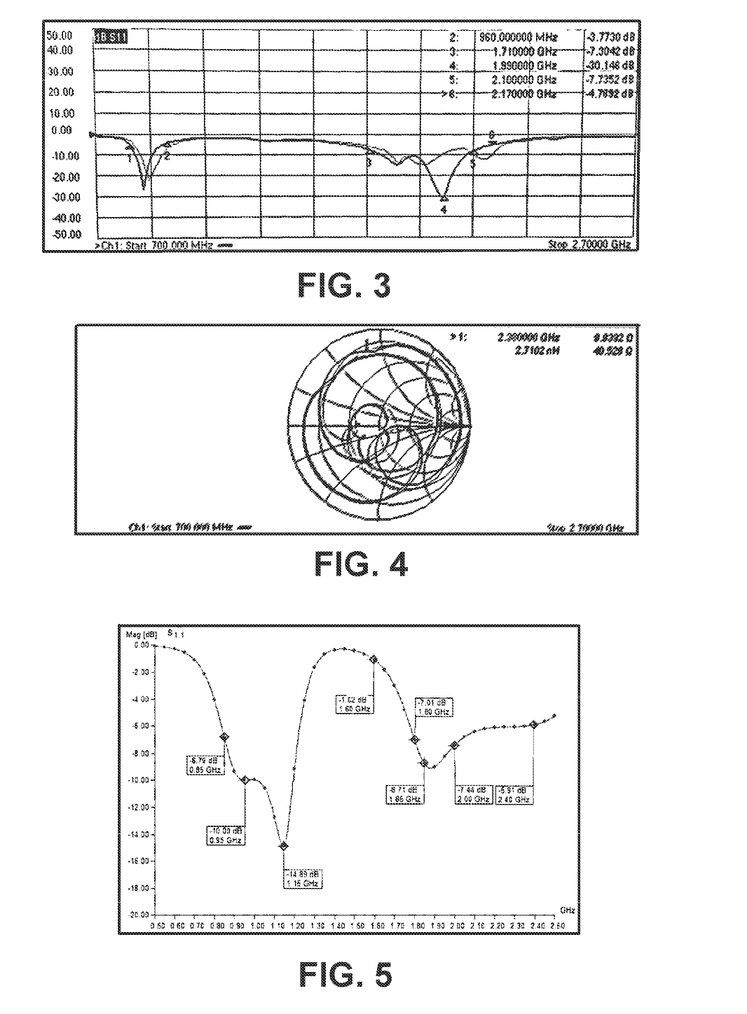

Performance characteristics of the preferred mode of the device 10 are outlined in the data plots of FIG. 3 and FIG. 4. In FIG. 3 shows the experimentally obtained the S₁₁ log magnitude plot.

FIG. 4 depicts the radiation plot of the current preferred mode of the device 10. As such, such reference to the disclosed construction of the device 10, and the depicting data plots, one skilled in the art could easily discern vast improvement found over prior art.

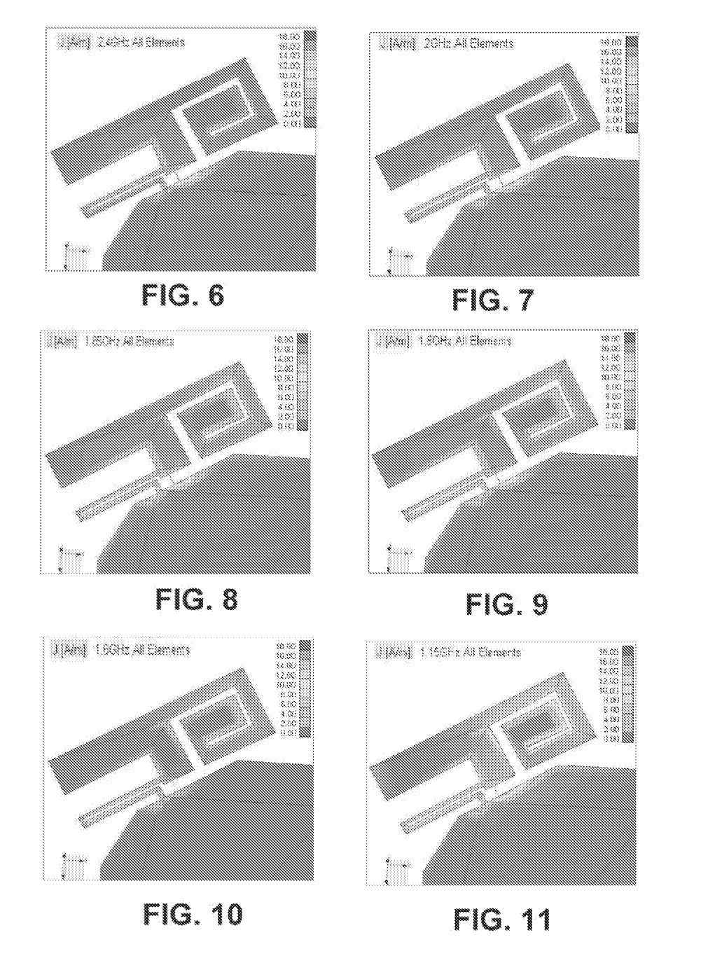

One skilled in the art can discern the advantages and improved performance characteristics of the antenna device 10 given the following experimentally obtained data. FIG. 5 depicts a return loss vs. frequency plot of the device 10. FIG. 6-FIG. 13 depict current density for the antenna device 10 in eight given frequencies. The depictions show color coded amplitudes of the radiation pattern calculated from current density vectors as is conventionally known numerical electromagnetic codes.

It is noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. An antenna element comprising:
a planar ground plane portion formed of electrically conductive material;
a radiator element defined by a perimeter edge extending to an engagement section electrically connected with said ground plane, said radiator element situated normal to a plane of the ground plane;
said radiator element having at least one meanderline antenna defined by a first cavity extending along a path from a first gap positioned at said perimeter edge of said radiator element extending to a terminating end point, substantially centered in the element; and
a connector operatively engaged with a feed point on said radiator element, said connector adapted for engagement with an RF transmission and/or reception device.

2. The antenna element of claim 1, additionally comprising:
said first cavity forming a first path having three right angled extensions in a meanderline fashion prior to reaching said terminating edge.

3. The antenna element of claim 2, additionally comprising:
along said first path of said cavity, there is included a first vertically disposed portion extending to a first of said three right angled turns;
a first horizontally disposed portion of said path of said cavity extending between said first of said three right angled turns to a second of said three right angled turns;
a second vertically disposed portion of said path of said cavity extending between said second of said three right angled turns; and
a second horizontally disposed portion of said path of said cavity extending from said third of said right angled turns.

4. The antenna element of claim 3, additionally comprising:
a second cavity formed into said radiator element extending from a second gap formed in said perimeter edge.

5. The antenna element of claim 4, additionally comprising:
a third cavity formed into said radiator element extending from a third gap formed in said perimeter edge.

6. The antenna element of claim 3, additionally comprising:
a second cavities formed into said radiator element from a gap formed in said perimeter edge.

7. The antenna element of claim 6, additionally comprising:
said first gap being sized to receive and transmit at a first RF frequency;
said second gap sized to receive and transmit at a second RF frequency; and
said third gap being sized to receive and transmit at a third RF frequency.

8. The antenna element of claim 3, additionally comprising:
said first path of said first cavity forming an antenna element for both horizontally polarized and vertically polarized RF transmission and reception.

9. The antenna element of claim 4, additionally comprising:
said first path of said first cavity forming an antenna element for both horizontally polarized and vertically polarized RF transmission and reception.

10. The antenna element of claim 5, additionally comprising:
said first path of said first cavity forming an antenna element for both horizontally polarized and vertically polarized RF transmission and reception.

11. The antenna element of claim 6, additionally comprising:
said first path of said first cavity forming an antenna element for both horizontally polarized and vertically polarized RF transmission and reception.

12. The antenna element of claim 7, additionally comprising:
said first path of said first cavity forming an antenna element for both horizontally polarized and vertically polarized RF transmission and reception.
